(19) United States
(12) Patent Application Publication
(10) Pub. No.: US 2026/0172064 A1
(43) Pub. Date: Jun. 18, 2026

(54) POWER DETECTION

(71) Applicant: HUAWEI TECHNOLOGIES CO., LTD., Shenzhen (CN)

(72) Inventors: Md Arif HUSSAIN ANSARI, Singapore (SG); Theng Tee Yeo, Singapore (SG); Tao Yan, Singapore (SG)

(21) Appl. No.: 19/417,555

(22) Filed: Dec. 12, 2025

Related U.S. Application Data
(63) Continuation of application No. PCT/CN2023/100272, filed on Jun. 14, 2023.

(51) Int. Cl. H04B 1/04; H01P 5/18

(52) U.S. Cl. CPC H04B 1/0458; H01P 5/18; H04B 2001/0416

(57) ABSTRACT

A electronic circuit generally comprises a transformer and a coupler. The transformer comprises a primary coil and a secondary coil, wherein the primary coil receives a first signal from a power amplifier, and the secondary coil is magnetically coupled with the primary coil and outputs a second signal to an antenna. The coupler comprises two coupling paths for obtaining a forward power and a reflected power for the second signal. Among the two coupling paths, a first coupling path is magnetically coupled with a first part of the primary coil and the secondary coil to generate a first voltage indicating the forward power for the second signal. In addition, a second coupling path is magnetically coupled with a second part of the primary coil and the second coil to generate a second voltage indicating a reflected power for the second signal.

### CROSS-REFERENCE TO RELATED APPLICATIONS

This application is a continuation of International Application No. PCT/CN2023/100272, filed on Jun. 14, 2023, the disclosure of which is hereby incorporated by reference in its entirety.

### FIELD

The present disclosure relates to a field of power detection, and specifically to an electronic circuit for detecting power, a transmitting apparatus and an electronic device.

### BACKGROUND

In various radio frequency applications, such as mobile phones, Wifi Routers, RF Transceivers, directional couplers, are increasingly important. For example, a directional coupler may be integrated at an output stage of a power amplifier (PA) in the transmitter chain. The power detector based on directional-coupler may be configured to sample, measure or detect the transmitting signal.

It is important to obtain accurate power detection, for example, the amplified transmitting power from the PA. With such an accurate detected power, it is possible to appropriately calibrate or optimize operation of a wireless transmitter. Directional-Couplers have been adopted to obtain the accurate power by detecting coupled-power to the Directional-couplers. In some conventional manners, a coupler may be positioned between a transformer, for example a Balun transformer, and an antenna. In these cases, the coupler is connected between a transformer and an antenna in a cascade manner. This configuration usually has a relatively large footprint and high signal loss.

### SUMMARY

In general, example embodiments of the present disclosure propose an electronic circuit, a transmitting apparatus and an electronic device for achieving bi-directional coupling without sacrificing chip area and insertion loss.

In a first aspect, there is provided an electronic circuit. The electronic circuit comprises a transformer and a coupler. The transformer comprises a primary coil and a second coil. The first coil is configured to receive a first signal from a power amplifier, and the secondary coil magnetically coupled with the primary coil and configured to output a second signal to an antenna. The coupler comprises a first coupling path and a second coupling path. The first coupling path is magnetically coupled with a first part of the primary coil and the secondary coil. The first coupling path is configured to generate a first voltage indicating a forward power for the second signal. The second coupling path is magnetically coupled with a second part of the primary coil and the second coil. The second coupling path is configured to generate a second voltage indicating a reflected power for the second signal.

According to example implementations of the present disclosure, both the forward and reflected powers of for the second signal can be obtained accordingly. In this way, since the powers of the second signal are obtained in both directions, the reliability of power detection can be improved and eventually the accuracy of power detection and calibration can be improved accordingly.

In some example implementations, the first coupling path comprises a first coil magnetically coupled to the transformer and configured to generate the first voltage indicating the forward power for the second signal. The second coupling path comprises a second coil magnetically coupled to the transformer and configured to generate the second voltage indicating the reflected power for the second signal. With these implementations, the coils of the transformer and the coupler can be organized in a more compact manner, thus occupying less area.

In some example implementations, the first coupling path further comprises a first isolation capacitor coupled between a first end of the first coil and a first terminal of the power amplifier. The first coupling path further comprises a first isolation resistor coupled between the first isolation capacitor and a ground terminal. With these implementations, by changing the parameter values of the first isolation capacitor and the first isolation resistor, the coupling and isolation factor of the first coupling path can be adjusted in a fast and convenient manner.

In some example implementations, the second coupling path further comprises a second isolation capacitor coupled between a first end of the second coil and a first terminal of the power amplifier. The second coupling path further comprises a second isolation resistor coupled between the second isolation capacitor and a ground terminal. With these implementations, the coupling and isolation factor of the second coupling path can be adjusted in a fast and convenient manner by changing the parameter values of the second isolation capacitor and the second isolation resistor.

In some example implementations, the first coupling path further comprises a first coupling resistor coupled between a second end of the first coil and a ground terminal, the second end being opposite to the first end. The first coupling path further comprises a first coupling capacitor coupled between the first coupling resistor and the antenna. With these implementations, by changing the parameter values of the first isolation capacitor and the first coupling capacitor, the coupling and isolation factor of the first coupling path can be adjusted quickly and conveniently.

In some example implementations, the second coupling path further comprises a second coupling resistor coupled between a second end of the second coil and a ground terminal, the second end being opposite to the first end. The second coupling path further comprises a second coupling capacitor coupled between the second coupling resistor and the antenna. With these implementations, by changing the parameter values of the second coupling capacitor and the second isolation capacitor, the coupling and isolation factor of the second coupling path can be adjusted in a low cost and reliable manner.

In some example implementations, the first coupling path further comprises a first coupling resistor coupled between a second end of the first coil and a ground terminal, the second end being opposite to the first end. The first coupling path further comprises a first coupling capacitor coupled between the first coupling resistor and an negative output terminal of the power amplifier. With these implementations, by changing the parameter values of the first coupling resistor and the first coupling capacitor, the coupling and isolation factor of the first coupling path can be adjusted in a fast and convenient manner.

In some example implementations, the second coupling path further comprises a second coupling resistor coupled between a second end of the second coil and a ground terminal, the second end being opposite to the first end. The second coupling path further comprises a second coupling capacitor coupled between the second coupling resistor and the antenna. With these implementations, by changing the parameter values of the second coupling resistor and the second coupling capacitor, the coupling and isolation factor of the second coupling path can be adjusted in a fast and convenient manner.

In some example implementations, the second coupling path further comprises a second coupling resistor coupled between a second end of the second coil and a ground terminal, the second end being opposite to the first end. The second coupling path further comprises a second coupling capacitor coupled between the second coupling resistor and a positive output terminal of the power amplifier. With these implementations, by changing the parameter values of the second coupling resistor and the second coupling capacitor, the coupling and isolation factor of the second coupling path can be adjusted in a fast and convenient manner.

In some example implementations, the coupler is provided adjacent to the transformer. In some example implementations, the coupler is provided inside the transformer, outside the transformer, above the transformer, below the transformer, or between the primary coil and the secondary coil. With these implementations, the size of the electronic circuit may be made much smaller.

In a second aspect, there is provided an electronic device, comprising a transformer and a coupler. The transformer is provided between a power amplifier and an antenna. The transformer comprises a primary coil coupled to the power amplifier and a secondary coil coupled to the antenna and magnetically coupled with the primary coil. The coupler comprises a first coupling path and a second coupling path. The first coupling path comprises a first coil adjacent to a first part of the primary coil and the secondary coil to magnetically couple with the first part. The second coupling path comprises a second coil adjacent to a second part of the primary coil and the secondary coil to magnetically couple with the second part.

In some example implementations, the first coupling path further comprises a first isolation capacitor coupled between a first end of the first coil and a first terminal of the power amplifier. The first coupling path further comprises a first isolation resistor coupled between the first isolation capacitor and a ground terminal.

In some example implementations, the second coupling path further comprises a second isolation capacitor coupled between a first end of the second coil and a first terminal of the power amplifier. The second coupling path further comprises a second isolation resistor coupled between the second isolation capacitor and a ground terminal.

In some example implementations, the first coupling path further comprises a first coupling resistor coupled between a second end of the first coil and a ground terminal, the second end being opposite to the first end. The first coupling path further comprises a first coupling capacitor coupled between the first coupling resistor and the antenna.

In some example implementations, the second coupling path further comprises a second coupling resistor coupled between a second end of the second coil and a ground terminal, the second end being opposite to the first end. The second coupling path further comprises a second coupling capacitor coupled between the second coupling resistor and the antenna.

In some example implementations, the first coupling path further comprises a first coupling resistor coupled between a second end of the first coil and a ground terminal, the second end being opposite to the first end. The first coupling path further comprises a first coupling capacitor coupled between the first coupling resistor and negative output terminal of the power amplifier.

In some example implementations, the second coupling path further comprises a second coupling resistor coupled between a second end of the second coil and a ground terminal, the second end being opposite to the first end. The second coupling path further comprises a second coupling capacitor coupled between the second coupling resistor and the antenna.

In some example implementations, the second coupling path further comprises a second coupling resistor coupled between a second end of the second coil and a ground terminal, the second end being opposite to the first end. The second coupling path further comprises a second coupling capacitor coupled between the second coupling resistor and a positive output terminal of the power amplifier.

In some example implementations, the coupler is provided inside of the transformer, outside the transformer, above the transformer or below the transformer.

In some example implementations, the coupler is provided between the primary coil and the secondary coil.

In a third aspect, there is provided a transmitting apparatus, comprising an antenna, and an electronic circuit according to the first or second aspect coupled to the antenna.

In a fourth aspect, there is provided an electronic device comprising a transmitting apparatus according to the third aspect and a power supply, the power supply being configured to supply power to the transmitting apparatus.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates an example electronic device in which the electronic circuit in accordance with an example embodiment of the present disclosure may be implemented;

FIG. 2 illustrates a diagram of an electronic circuit in accordance with a related approach;

FIG. 3 illustrates an example layout of the electronic circuit shown in FIG. 2;

FIG. 4 illustrates a circuit diagram of an electronic circuit in accordance with an example embodiment of the present disclosure;

FIG. 5 illustrates an example layout of the example electronic circuit shown in FIG. 4;

FIG. 6 illustrates an example implementation of the example electronic circuit shown in FIG. 5, wherein the coils of the electronic circuit are shown with layout representation;

FIG. 7 illustrates an example implementation of the example electronic circuit in accordance with another example embodiment of the present disclosure; and

FIG. 8 illustrates an example implementation of the example electronic circuit in accordance with a further example embodiment of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

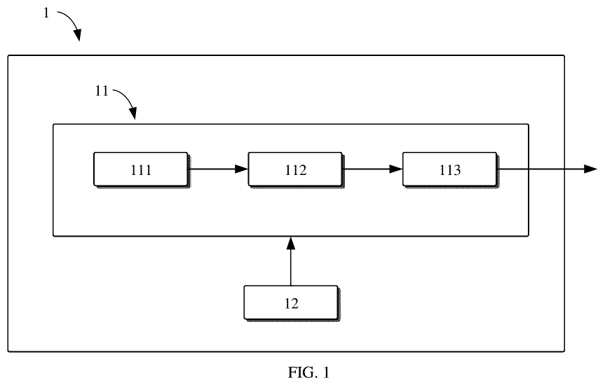

FIG. 1 illustrates an example electronic device 1 in which the electronic circuit in accordance with an example embodiment of the present disclosure may be implemented. As shown, the electronic device 1 generally includes a transceiver 11 and a power supply 12. The power supply 12 supplies power to the transceiver 11 to ensure the normal operation of the transceiver 11. The transceiver 11 includes, among other things, a power amplifier 111, an antenna 113 and an electronic circuit 112 coupled to the power amplifier 111 and the antenna 113. In an embodiment, the electronic circuit 112 may comprise a transformer, such as a Balun, and a coupler, such as a directional coupler. A signal may be transmitted from the power amplifier 111 to the antenna 113 via the electronic circuit 112. It is to be understood that the illustrated electronic device 1 is only illustrative without limiting scope of the disclosure.

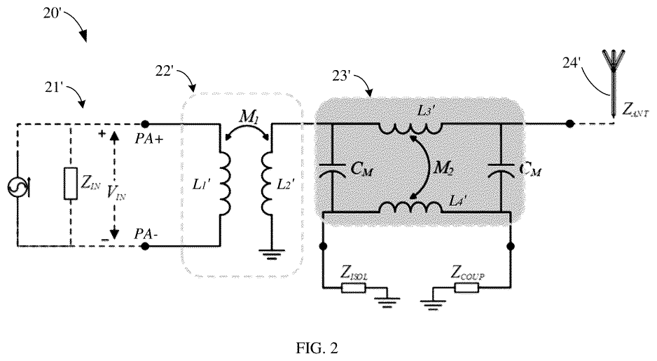

As described above, the related configuration of coupler and transformer usually has a relative large footprint or size. FIG. 2 illustrates a diagram of an electronic circuit 20′ in accordance with a related directional coupler. As shown, the electronic circuit 20′ generally includes a power amplifier 21′, a transformer 22′, a coupler 23′ and an antenna 24′. The transformer 22′ may be implemented as a Balun in an example, and is coupled between the power amplifier 21′ and the antenna 24′ together with the coupler 23′. The transformer 22′ and the coupler 23′ thus are connected in a cascade manner.

The transformer 22′ includes a primary coil L₁′ and a secondary coil L₂′. The primary coil L₁′ is coupled to the power amplifier 21′ and is used in an example to receive a signal from the power amplifier 21′. The secondary coil L₂′ is magnetically coupled with the primary coil L₁′ to output a signal to the coupler 23′. The coupler 23′ is coupled between the secondary coil L₂′ and the antenna 24′, and includes a first coil L₃′ and a second coil L₄′. With the coupler 23′, an induced signal can be formed in the second coil L₄′ based on the signal transmitted through the first coil L₃′. Characteristics of the induced signal may thus represent the characteristics of the signal transmitted through the first coil L₃′, such as power of the amplified signal. A resistor Z_{coup} is coupled to the second coil L₄′ so as to detect the signal. Based on the signal, the transmitted power from power amplifier 21′ to the antenna 24′ can be determined accordingly.

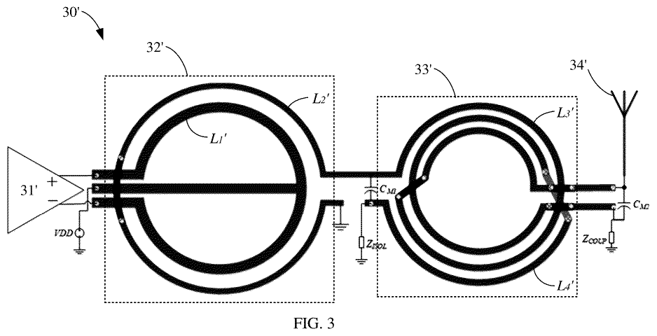

FIG. 3 illustrates an example layout of the electronic circuit shown in FIG. 2. The transformer 32′ comprising the primary coil L₁′ and the secondary coil L₂′ is implemented as a coil assembly. The coupler 33′ comprising the first coil L₃′ and the second coil L₄′ is implemented as the other coil assembly. Thus, the electronic circuit 30′ generally includes two coil assemblies. Since the two coil assemblies are connected and implemented in a cascade manner, each coil assembly occupies an independent footprint. The overall footprint of the two coil assemblies is basically the sum of the two independent footprints, causing a relatively large overall footprint or area. Since the two coil assemblies occupy a relatively large area of the chip associated with the electronic circuit 30′, the chip has to include more space to accommodate the two coil assemblies. Therefore, it is difficult for the related chip to be miniaturized, limiting the application scenarios. Moreover, the first coil L₃′ provided between the secondary coil L₂′ and the antenna 34′ will incur insertion loss during the transmission of the signal.

In addition, the accurate power detection and calibration requires forward and reflected power detection. The coupler 23′ theoretically can detect forward power at Z_{coup} and reflected power at Zᵢₛₒₗ. However, connecting a power detector at Zᵢₛₒₗ will practically disturb the coupling and isolation factor and arises reliability issue. To make the power detection reliable, usually Zᵢₛₒₗ is terminated with fix load. An additional coupler between 23′ and 24′ would require for reliable forward and reflected power detection. However, it will require additional chip footprint and increases losses.

To at least address the above issues in the current electronic circuit 20′, 30′, embodiments of the present disclosure propose new architectures. The electronic circuit according to the example embodiments of the present disclosure does not provide a coil between the transformer such as Balun and the antenna. Rather, it enables a direct connection between the transformer and the antenna. In this way, the overall footprint of the transformer and the coupler may be reduced. In addition, the insertion loss caused by the coil between the transformer and the antenna can be avoided. In addition, the electronic circuit according to the present disclosure adopts two coupling paths to detect the forward power and the reflected power respectively, which enables the accurate detections of the transmitted signals.

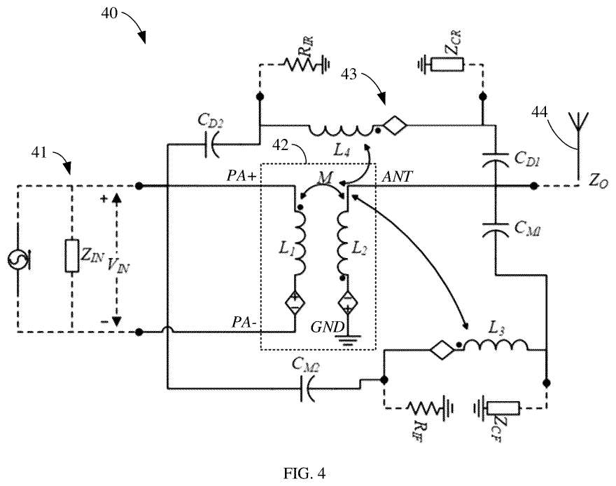

Example embodiments of the present disclosure will be described in more detail hereinafter with reference to FIGS. 4-8. FIG. 4 illustrates a circuit diagram of an electronic circuit 40 in accordance with an example embodiment of the present disclosure. As shown in FIG. 4, the electronic circuit 40 generally includes a transformer 42 and a coupler 43. The transformer 42 is a Balun in an example, and includes a primary coil L₁ and a secondary coil L₂. The primary coil L₁ is coupled to a power amplifier 41, and is used to receive a first signal from the power amplifier 41. The secondary coil L₂ is magnetically coupled with the primary coil L₁, and is coupled to an antenna 44. The secondary coil L₂ outputs a second signal to the antenna 44.

As shown, the transformer 42 has a first input terminal PA+, a second input terminal PA− and an output terminal ANT. The primary coil L₁ is coupled between the first input terminal PA+ and the second input terminal PA−, and the first input terminal PA+ and the second input terminal PA− are coupled to positive and negative output terminals of the differential power amplifier 21, respectively. The secondary coil L₂ is coupled between the output terminal ANT and a reference terminal, for example a ground terminal GND, and the output terminal ANT is directly coupled to the antenna 44. The amplified signal generated by the PA may be tailored to an appropriate signal for the antenna with the transformer 42.

The coupler 43 includes two coupling paths, i.e., a first coupling path and a second coupling path. The first coupling path is magnetically coupled with a first part of the primary coil L₁ and the secondary coil L₂. For example, the first coupling path is magnetically coupled with the secondary coil L₂. The first coupling path is configured to generate a first voltage indicating a forward power for the second signal from the transformer 42. The first coupling path further comprises a first isolation capacitor C_{M2}. The first isolation capacitor C_{M2} is coupled between a first end of the first coil L₃ and a positive output terminal of the power amplifier 41 to at least partially determine a coupling and isolation factor of the first coupling path, which is an important factor to evaluate the performance of the first coupling path. In the illustrated embodiment, the first coupling path may further comprise a first isolation resistor R_{IF}. The first isolation resistor R_{IF} may be coupled between the first isolation capacitor C_{M2} and a ground terminal GND.

The second coupling path further includes a second isolation capacitor C_{D2} and a second isolation resistor R_{IR}. The second isolation capacitor C_{D2} is coupled between a first end of the second coil L₄ and a positive output terminal of the power amplifier 41 to at least partially determine a coupling and isolation factor of the second coupling path. In the illustrated embodiment, the second isolation resistor R_{IR} may be coupled between the second isolation capacitor C_{D2} and a ground terminal GND.

The first coupling path further includes a first coupling resistor Z_{CF} and a first coupling capacitor C_{M1}. The first coupling resistor Z_{CF} may be coupled between a second end of the first coil L₃ and a ground terminal GND, and the second end is opposite to the first end. In the illustrated embodiment, the first coupling capacitor C_{M1} is coupled between the first coupling resistor Z_{CF} and the antenna to at least partially determine a coupling and isolation factor of the first coupling path. The forward power may be detected at the first coupling resistor Z_{CF}. By providing the first coupling resistor Z_{CF} to the first coupling path, a desired coupling with good isolation between the antenna and the forward coupled port can be achieved, thus improving the directivity of the first coupling path. It is to be understood that the first coupling resistor Z_{CF} may also be implemented with other forms of an impedance.

The second coupling path further includes a second coupling resistor Z_{CR} and a second coupling capacitor C_{D1}. The second coupling resistor Z_{CR} may be coupled between a second end of the second coil L₄ and a reference terminal, such as a ground terminal GND, and the second end is opposite to the first end. In the illustrated embodiment, the second coupling capacitor C_{D1} may be coupled between the second coupling resistor Z_{CR} and the antenna, to at least partially determine a coupling and isolation factor of the second coupling path. The reflected power may be detected at the second coupling resistor Z_{CR}. By providing the second coupling resistor Z_{CR} to the second coupling path, a desired coupling with good isolation between the power amplifier and the reflected coupled port can be achieved, thus improving the directivity of the second coupling path. It is to be understood that the second coupling resistor Z_{CR} may also be implemented with other forms of an impedance.

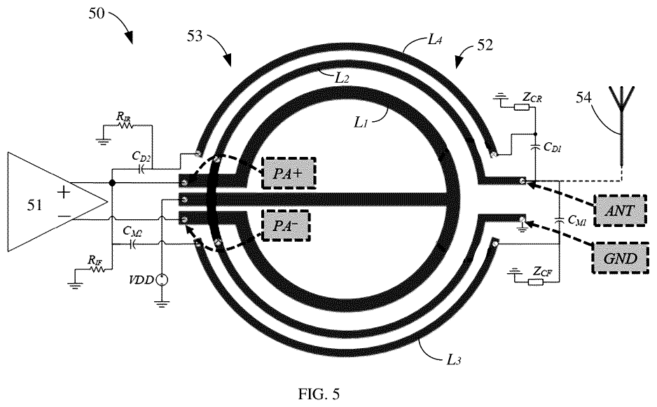

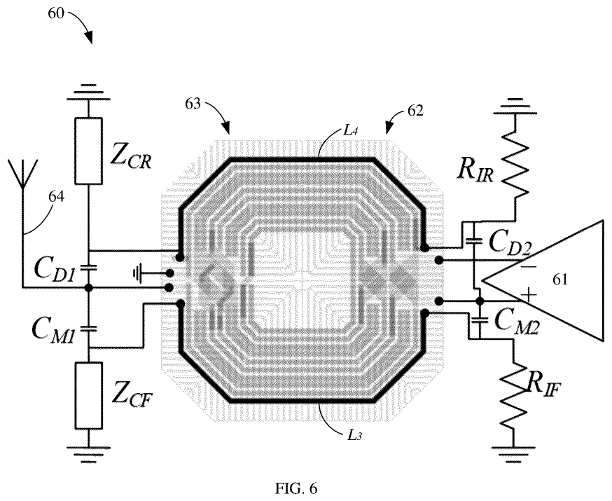

FIG. 5 illustrates an example layout of the example electronic circuit shown in FIG. 4, and FIG. 6 illustrates an example implementation of the example electronic circuit shown in FIG. 5. FIG. 5 and FIG. 6 are intended to illustrate example layout and the implementations of the coils. Thus, description for the components other than coils will be omitted here for brevity. In an embodiment as shown in FIG. 5, the primary coil L₁ is formed inside the secondary coil L₂. In another embodiment, the primary coil L₁ may be formed outside the secondary coil L₂. There is no restriction to the position of the primary coil L₁ and the secondary coil L₂, as long as they can operate to achieve function of a transformer. The secondary coil L₂ of the transformer 52 is in a direct connection to the antenna 54. As a result, there will be no insert loss in the electronic circuit 50.

A first coil L₃ of the first path is provided adjacent to the first part of the primary coil L₁ and the secondary coil L₂ to magnetically couple with the first part. In FIG. 5, the first coil L₃ is positioned outside the secondary coil L₂. Alternatively, the first coil L₃ may be positioned inside, above or below the secondary coil L₂.

The second coupling path is magnetically coupled with a second part of the primary coil L₁ and the secondary coil L₂. The second coupling path is configured to generate a second voltage indicating a reflected power for the second signal. A second coil L₄ of the second coupling path is provided adjacent to the second part of the primary coil L₁ and the secondary coil L₂ to magnetically couple with the second part. In FIG. 4, the second coil L₄ is positioned outside the secondary coil L₂. Alternatively, the second coil L₄ may be positioned inside, above or below the secondary coil L₂.

With reference to FIG. 5, the first coil L₃ of the transformer 52 is located outside the secondary coil L₂ of the coupler 53 and the second coil L₄ of the transformer 52 is located outside the primary coil L₁. In other words, the coils of the transformer 52 are positioned in a concentric arrangement, and the coils of the coupler 53 are positioned to surround the coils of the transformer. Thus, the coils of the transformer 52 and the coupler 53 are organized in a more compact manner, occupying less area. Therefore, no additional chip area is required and the size of the associated chip can be made smaller to adapt to more scenarios.

It is to be understood that the spatial locations of the first coil L₃ and the second coil L₄ are only illustrative without limiting scope of the disclosure. They can be adjusted according to the spatial considerations of the actual applications, as long as that they are close enough to induce power from the primary coil L₁ and/or the secondary coil L₂. For example, in other example embodiments, the locations of the first coil L₃ and the second coil L₄ of the coupler 53 may be designed to be inside the transformer 52. Alternatively, the coils of the couplers 53 may be positioned between the primary coil L₁ and the secondary coil L₂ in an interleaved manner. In other words, the coils of the transformer 52 and the coils of the coupler 53 may be interleaved in the same plane.

In other example embodiments, the locations of the first coil L₃ and the second coil L₄ of the coupler 53 may be positioned above or below the transformer 52. In further example embodiments, the first coil L₃ may be located between the primary coil L₁ and the secondary coil L₂ of the transformer 52, and the second coil L₄ may be positioned outside or inside the primary coil L₁ and the secondary coil L₂ of the transformer 52.

According to the example embodiments described above, one coupling path of the coupler is provided for forward power detection, and the other coupling path of the coupler is provided for reflected power detection. Both the forward and reflected powers of the second signal can be determined accordingly. In this way, example embodiments according to the present disclosure can be used to analyze the load impedance, which can be further used for improve power calibration accuracy, load tuning etc. By detecting powers of for the second signal in both directions utilizing different coupling path, the reliability of power detection can be improved and eventually the accuracy of power detection and calibration can be improved accordingly.

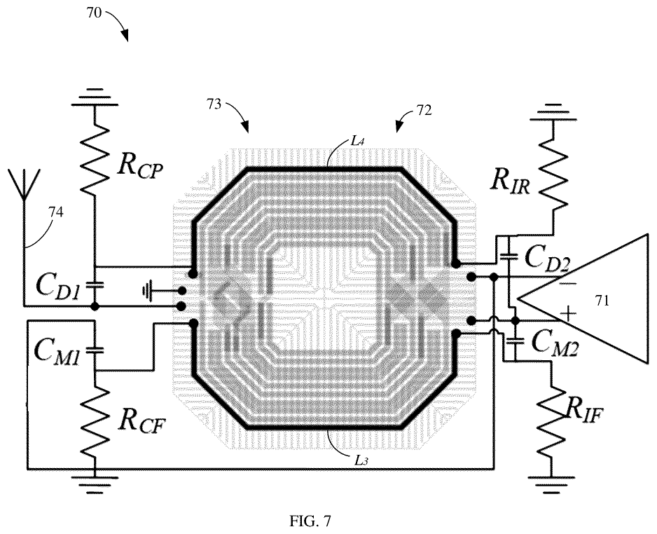

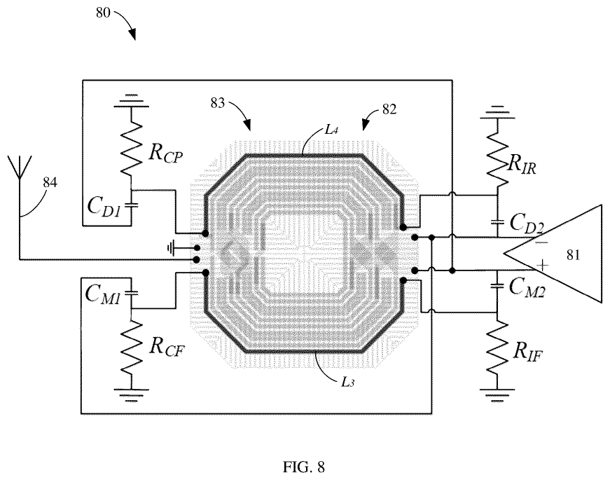

In FIG. 6, the coils may be implemented in a shape of a part of a polygon. This is only for illustration without limiting scope of the present disclosure. Other shapes are possible, as long as they can generate induced signals. In addition, the coils are formed in a plain stripe, and this is also illustrative only. FIGS. 7 and 8 illustrate an example implementation of the example electronic circuit in accordance with different example embodiment of the present disclosure, respectively. FIGS. 7-8 mainly differ from FIG. 6 in the specific arrangement of the capacitors and resistors.

As can be seen from FIG. 7, the electronic circuit 70 may include a first coupling resistor R_{CF} coupled between a second end of the first coil L₃ and a ground terminal GND, and the second end being opposite to the first end of the first coil L₃. In the illustrated embodiment, the electronic circuit 70 may further include a first coupling capacitor C_{M1} which is coupled between the first coupling resistor R_{CF} and a negative output terminal of the power amplifier 71. The first coupling capacitor C_{M1} may be provided to at least partially determine a coupling and isolation factor of the first coupling path. In FIG. 7, the first coil L₃ and the second coil L₄ are positioned outside the Balun. In another embodiment, the first coil L₃ and the second coil L₄ may be formed in other positions relative to the Balun. Alternatively, the second coil L₄ may be positioned inside, above or below the Balun. There is no restriction to the position of the first coil L₃ and the second coil L₄, as long as they can operate to achieve function of the transformer.

As can be seen from FIG. 7, the electronic circuit 70 may include a second coupling resistor R_{CP} coupled between a second end of the second coil L₄ and a ground terminal GND, and the second end being opposite to the first end of the second coil L₄. In the illustrated embodiment, the electronic circuit 70 may further include a second coupling capacitor C_{D1} coupled between the second coupling resistor R_{CP} and the antenna and may be provided to at least partially determine a coupling and isolation factor of the second coupling path. In FIG. 7, the coils may be implemented in a shape of a part of a polygon. This is only for illustrative without limiting scope of the present disclosure. Other shapes are possible, as long as they can generate induced signals. In addition, the coils are formed in a plain stripe, and this is also illustrative only.

FIG. 8 differs from FIG. 7 mainly in the specific electrical connections of the second coupling capacitor C_{D1}. Similar to FIG. 7, the second coupling resistor R_{CP} as shown in FIG. 8 is coupled between a second end of the second coil L₄ and a ground terminal GND. Different from FIG. 7, in the illustrated embodiment as shown in FIG. 8, the second coupling capacitor C_{D1} may be coupled between the second coupling resistor R_{CP} and a positive output terminal of the power amplifier 81 and may be provided to at least partially determine a coupling and isolation factor of the second coupling path. In FIG. 8, the coils may be implemented in a shape of a part of a polygon. This is only for illustrative without limiting scope of the present disclosure. Other shapes are possible, as long as they can generate induced signals. In addition, the coils are formed in a plain stripe, and this is also illustrative only.

It is to be understood that even though the above embodiments are described by using directional coupler as an example scenario, it is readily envisaged that this is only illustrative, rather than restrictive. The electronic circuit according to the present disclosure may be used in other scenarios.

With various placements of the capacitor and resistor, the parameters of the capacitors and the resistors may be similar or different among different placements, which may depend on different requirement of the users. For example, the parameter value of the first isolation capacitor C_{M2} in the embodiment as shown in FIG. 7 is different from that of the first isolation capacitor C_{M2} in the embodiment as shown in FIG. 8, or the value of the second isolation resistor R_{IR} in the embodiment as shown in FIG. 7 is different from that as shown in FIG. 8. In this way, the user may envisage a variety of placements of capacitors and resistors to achieve the intended purpose. In this way, by changing the parameter values of the specific devices, the coupling and isolation factor of the first and/or second coupling path can be adjusted in a fast and convenient manner. It is to be understood that the specific placements as shown in FIGS. 7-8 are just a few examples, and they are not limited to embodiments of the present disclosure.

Example embodiments of the present disclosure further relate to a transmitting apparatus. The transmitting apparatus includes an antenna and an electronic circuit coupled to the antenna. The electronic circuit may be any electronic circuit described above. The transmitting apparatus may also include a power amplifier, coupler, antenna and the electronic circuit may be coupled/connected between the antenna and the power amplifier.

Example embodiments of the present disclosure also relate to an electronic device. The electronic device includes a transmitting apparatus described above and a power supply configured to supply power to the transmitting apparatus.

Compared with the existing solutions of electronic circuit, the embodiments according to the present disclosure enable bi-directional power detection without sacrificing chip area and insertion loss. Therefore, a miniaturized coupler with electrically smaller size can be achieved.

While several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. An electronic circuit, comprising:
a transformer comprising:
a primary coil configured to receive a first signal from a power amplifier; and
a secondary coil magnetically coupled with the primary coil and configured to output a second signal to an antenna; and
a coupler comprising:
a first coupling path, magnetically coupled with a first part of the primary coil and the secondary coil and configured to generate a first voltage indicating a forward power for the second signal; and
a second coupling path, magnetically coupled with a second part of the primary coil and the second coil and configured to generate a second voltage indicating a reflected power for the second signal.

2. The electronic circuit of claim 1, wherein the first coupling path comprises a first coil magnetically coupled to the transformer and configured to generate the first voltage indicating the forward power for the second signal; and
wherein the second coupling path comprises a second coil magnetically coupled to the transformer and configured to generate the second voltage indicating the reflected power for the second signal.

3. The electronic circuit of claim 2, wherein the first coupling path further comprises:
a first isolation capacitor coupled between a first end of the first coil and a first terminal of the power amplifier, and
a first isolation resistor coupled between the first isolation capacitor and a ground terminal.

4. The electronic circuit of claim 2, wherein the second coupling path further comprises:
a second isolation capacitor coupled between a first end of the second coil and a first terminal of the power amplifier, and
a second isolation resistor coupled between the second isolation capacitor and a ground terminal.

5. The electronic circuit of claim 3, wherein the first coupling path further comprises:
a first coupling resistor coupled between a second end of the first coil and a ground terminal, the second end being opposite to the first end, and
a first coupling capacitor coupled between the first coupling resistor and the antenna.

6. The electronic circuit of claim 4, wherein the second coupling path further comprises:
a second coupling resistor coupled between a second end of the second coil and a ground terminal, the second end being opposite to the first end, and
a second coupling capacitor coupled between the second coupling resistor and the antenna.

7. The electronic circuit of claim 3, wherein the first coupling path further comprises:
a first coupling resistor coupled between a second end of the first coil and a ground terminal, the second end being opposite to the first end, and
a first coupling capacitor coupled between the first coupling resistor and a negative output terminal of the power amplifier.

8. The electronic circuit of claim 4, wherein the second coupling path further comprises:
a second coupling resistor coupled between a second end of the second coil and a ground terminal, the second end being opposite to the first end, and
a second coupling capacitor coupled between the second coupling resistor and the antenna.

9. The electronic circuit of claim 4, wherein the second coupling path further comprises:
a second coupling resistor coupled between a second end of the second coil and a ground terminal, the second end being opposite to the first end, and
a second coupling capacitor coupled between the second coupling resistor and a positive output terminal of the power amplifier.

10. The electronic circuit of claim 1, wherein the coupler is provided adjacent to the transformer.

11. The electronic circuit of claim 10, wherein the coupler is provided inside the transformer, outside the transformer, above the transformer, or below the transformer.

12. An electronic device, comprising:
a transformer provided between a power amplifier and an antenna, the transformer comprising:
a primary coil coupled to the power amplifier; and
a secondary coil coupled to the antenna and magnetically coupled with the primary coil; and
a coupler comprising:
a first coupling path comprising a first coil adjacent to a first part of the primary coil and the secondary coil to magnetically couple with the first part; and
a second coupling path comprising a second coil adjacent to a second part of the primary coil and the secondary coil to magnetically couple with the second part.

13. The electronic device of claim 12, wherein the first coupling path further comprises:
a first isolation capacitor coupled between a first end of the first coil and a first terminal of the power amplifier, and
a first isolation resistor coupled between the first isolation capacitor and a ground terminal.

14. The electronic device of claim 12, wherein the second coupling path further comprises:
a second isolation capacitor coupled between a first end of the second coil and a first terminal of the power amplifier, and
a second isolation resistor coupled between the second isolation capacitor and a ground terminal.

15. The electronic device of claim 13, wherein the first coupling path further comprises:
a first coupling resistor coupled between a second end of the first coil and a ground terminal, the second end being opposite to the first end, and
a first coupling capacitor coupled between the first coupling capacitor and the antenna.

16. The electronic device of claim 14, wherein the second coupling path further comprises:
a second coupling resistor coupled between a second end of the second coil and a ground terminal, the second end being opposite to the first end, and
a second coupling capacitor coupled between the second coupling capacitor and the antenna.

17. The electronic device of claim 13, wherein the first coupling path further comprises:
a first coupling resistor coupled between a second end of the first coil and a ground terminal, the second end being opposite to the first end, and
a first coupling capacitor coupled between the first coupling resistor and a negative output terminal of the power amplifier.

18. The electronic device of claim 14, wherein the second coupling path further comprises:
a second coupling resistor coupled between a second end of the second coil and a ground terminal, the second end being opposite to the first end; and
a second coupling capacitor coupled between the second coupling resistor and the antenna.

19. The electronic device of claim 14, wherein the second coupling path further comprises:
a second coupling resistor coupled between a second end of the second coil and a ground terminal, the second end being opposite to the first end; and
a second coupling capacitor coupled between the second coupling resistor and a positive output terminal of the power amplifier.

20. The electronic device of claim 12, wherein the coupler is provided inside the transformer, outside the transformer, above the transformer or below the transformer.
